(19) United States
(12) Patent Application Publication
(10) Pub. No.: US 2025/0301442 A1
(43) Pub. Date: Sep. 25, 2025

(54) FLEXIBLE GNSS AND WLAN RECEIVER

(71) Applicant: QUALCOMM Incorporated, San Diego, CA (US)

(72) Inventors: Gregory STEELE, Pleasanton, CA (US); Patrick Poon-Cheuk CHAN, San Jose, CA (US); Zhiqun LIU, Foster City, CA (US); Sarin MATHEN, Sunnyvale, CA (US); Sandip HOMCHAUDHURI, San Jose, CA (US); Senthilkannan CHANDRASEKARAN, Bangalore (IN); Vincent Knowles JONES, Redwood City, CA (US); Chun Woo LEE, Pleasanton, CA (US)

(21) Appl. No.: 18/611,194

(22) Filed: Mar. 20, 2024

(51) Int. Cl. H04W 64/00

(52) U.S. Cl. CPC H04W 64/003

(57) ABSTRACT

Techniques are provided for obtaining global navigation satellite system (GNSS) measurements utilizing shared resources in a wireless node, such as an access point in a wireless wide area network (WLAN). An example method for obtaining a position estimate with an access point includes receiving, with one or more receive chains in the access point, radio frequency signals associated with a wireless network transmitted from a plurality of user equipment, determining a positioning opportunity, receiving, with at least one of the one or more receive chains, radio frequency signals transmitted from a satellite vehicle based at least in part on determining the positioning opportunity, and estimating a position of the access point based at least in part on the radio frequency signals transmitted from the satellite vehicle.

### BACKGROUND

The use of wireless devices for many everyday activities is becoming common. Modern wireless devices may make use of one or more wireless communication technologies. For example, a wireless device may communicate in a wireless local area network (WLAN) using a short range communication technology such as WiFi technology, Bluetooth® technology, ultrawideband (UWB) technology, millimeter wave (mmWave) technology, etc. The use of short range communication technologies, such as WiFi and Bluetooth®, in wireless devices has become much more common in the last several years and is regularly used in retail businesses, offices, homes, cars, manufacturing operations, and public gathering places. Access points may be installed to enable data communication between wireless devices and a network. Some access points may enable access to the Internet. Short range communication technologies may be used in ranging and radio frequency sensing operations. In an example, indoor positioning applications may utilize ranging measurements obtained from network stations. The accuracy of ranging and positioning applications may be based at least in part on obtaining the location of the access points. Global Navigation Satellite Systems (GNSS) may be used to obtain the geographic location of an access point.

### SUMMARY

An example method for obtaining a position estimate with an access point according to the disclosure includes receiving, with one or more receive chains in the access point, radio frequency signals associated with a wireless network transmitted from a plurality of user equipment, determining a positioning opportunity, receiving, with at least one of the one or more receive chains, radio frequency signals transmitted from a satellite vehicle based at least in part on determining the positioning opportunity, and estimating a position of the access point based at least in part on the radio frequency signals transmitted from the satellite vehicle.

An example method for configuring receive chains in a wireless node according to the disclosure includes configuring a plurality of receive chains in a wireless node to operate with a wireless network, configuring a first set of the plurality of receive chains to operate with a global navigation satellite system, and a second set of the plurality of receive chains to operate with the wireless network, and estimating a position of the wireless node based at least in part on radio frequency signals received from satellite vehicles in the global navigation satellite system.

An example method for obtaining a position estimate with a wireless node according to the disclosure includes receiving radio frequency signals transmitted from at least one network station with a plurality of receive chains in the wireless node, receiving radio frequency signals transmitted from a satellite vehicle with at least one of the plurality of receive chains in the wireless node, and estimating a position of the wireless node based at least in part on the radio frequency signals transmitted from the satellite vehicle.

An example method for configuring a wireless node for network communication and satellite navigation operations according to the disclosure includes configuring, at a first time, a plurality of analog circuits and at least one processor in the wireless node for digital communication operations on a wireless network, and configuring, at a second time, at least one of the plurality of analog circuits to receive satellite signals, and the at least one processor in the wireless node for digital communication operation and satellite navigation operations.

Items and/or techniques described herein may provide one or more of the following capabilities, as well as other capabilities not mentioned. A wireless node in a wireless network may have multiple receive chains in a receiver. One or more of receive chains may be dynamically configured to receive radio frequency signals transmitted by network stations or radio frequency signals transmitted by a global navigation satellite system (GNSS). The wireless node may be configured to perform positioning operations based on internal or external requirements. During positioning operations, one or more of the receive chains may be utilized to receive GNSS signals from one or more satellite vehicles. When the positioning operations are complete, the receive chains may be fully allocated to receive wireless network traffic. The GNSS receiver may be implemented in software executing on the wireless node. A network resource may provide scheduling information to the wireless node and other network stations. The cost of wireless nodes may be reduced by the elimination of dedicated GNSS receivers in the wireless node. Network communications may continue during positioning operations. Other capabilities may be provided and not every implementation according to the disclosure must provide any, let alone all, of the capabilities discussed.

### BRIEF DESCRIPTION OF THE DRAWINGS

FIG. 1 is a diagram of an example wireless local area network (WLAN).

FIG. 2 is a block diagram of components of an example wireless node or user equipment.

FIG. 3 is a block diagram of components of an example access point.

FIG. 4A is a block diagram of components of an example wireless node with receive chains configured to operate with a wireless network.

FIG. 4B is a block diagram of components of the example wireless node in FIG. 4A with receive chains configured to operate with a wireless network and a global satellite navigation system.

FIG. 5 is a block diagram of components of an example wireless node with at least one receive chain configured to operate with a wireless network and a global satellite navigation system.

FIG. 6 is a block diagram of components of an example front end of a GNSS receiver.

FIG. 7 is a block diagram of example radio frequency analog components in a receive chain

FIG. 8 is an example message flow diagram for coordinating positioning operations in a wireless network.

FIG. 9 is a process flow diagram of an example method for configuring receive chains in a wireless node.

FIG. 10 is a process flow diagram of an example method for obtaining a position estimate with an access point.

FIG. 11 is a process flow diagram of an example method for configuring a wireless node for network communications and satellite navigation operations.

### DETAILED DESCRIPTION

Techniques are discussed herein for obtaining global navigation satellite system (GNSS) measurements utilizing shared resources in a wireless node, such as an access point in a wireless wide area network (WLAN). A WLAN platform may include receive chains configured to receive radio frequency signals transmitted by wireless nodes. One or more of the receive chains may also be configured to obtain GNSS measurements while one or more of the other receive chains are receiving signals from the wireless network. In an example, hardware components in the WLAN platform such as the Radio Frequency and Analog (RFA), Analog-to-Digital (ACD) convertors, Receiver Front End (RXFE), and associated receive chain components may be shared between a WLAN receiver Back End (RXBE) and a GNSS receiver. The GNSS receive functionality may be implemented in software running on the WLAN platform. In an example, the WLAN platform may be configured to allocate all receive chain resources for WLAN operations (e.g., network communications), and when there is a need for a location measurement, one or more of the receive chains may be reconfigured from WLAN to GNSS operations. The reconfiguration may be based on the available While the GNSS is in operation, WLAN operations may continue at a reduced capability. Once the GNSS measurement is complete, the receive chains may be switched back to full allocation to WLAN operations.

A WLAN AP and/or a coordinating server may be configured to opportunistically perform GNSS measurements utilizing shared resources with the WLAN AP. In an example, the GNSS measurements may be based on time of date, date, traffic information, historical information, enterprise AP vs consumer AP, new station configurations (e.g., addition, removal, relocation of an AP), or other network requirements. The AP (or other network resource) may be configured to proactively indicate reduced WLAN capabilities when sharing with GNSS is enabled, and may coordinate with neighboring APs to maintain a quality of service for the network devices. For example, a network server may be configured to schedule when APs will have reduced capabilities (e.g., staggered and/or simultaneous location measurements), and when to utilize other positioning techniques (e.g., schedule ranging operations with non-GNSS enabled APs).

Particular aspects of the subject matter described in this disclosure may be implemented to realize one or more of the following potential advantages. The locations of base stations in a network may be obtained. Sharing receive chains for communications and GNSS operations may enable cost reductions for an AP or other wireless node. An AP may be configured for simultaneous network and positioning operations. Obtaining GNSS based location estimates for APs in a network may be combined with terrestrial measurements (e.g., round trip time (RTT), reference signal strength indicator (RSSI), time of arrival (TOA), etc.) to improve the location estimates for low complexity devices (e.g., reduced capability UEs, Internet of Things (IoT) devices, asset tags, etc.) and legacy APs (e.g., non-GNSS enabled). Other advantages may also be realized.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

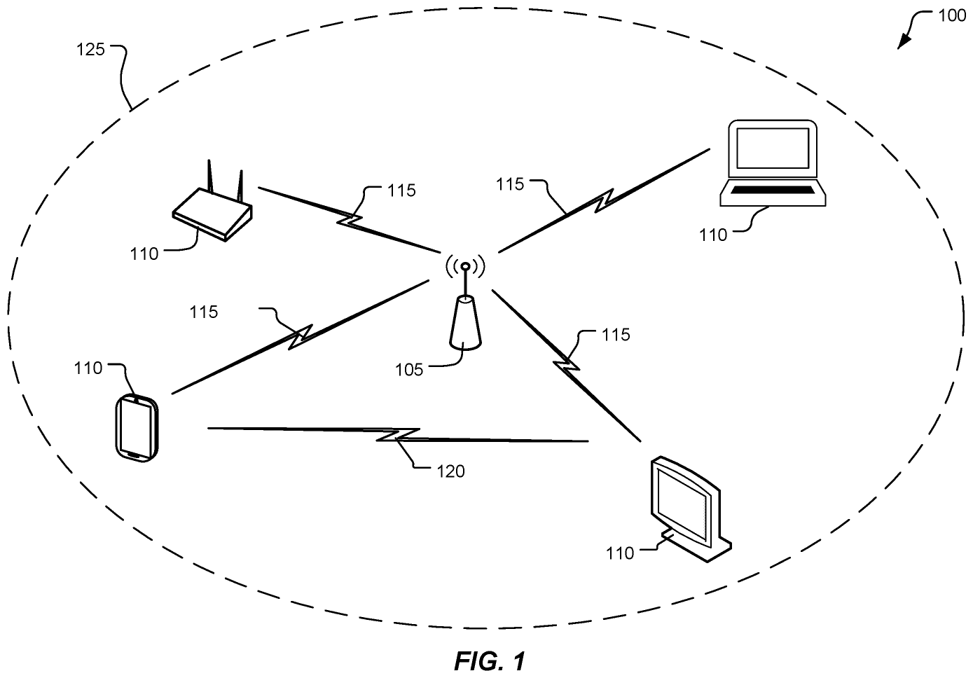

Referring to FIG. 1, a block diagram illustrates an example of a WLAN network 100 such as, e.g., a network implementing IEEE 802.11 and IEEE 802.15 families of standards. The WLAN network 100 may include an access point (AP) 105 and one or more wireless devices 110 or stations (STAs) 110, such as mobile stations, head mounted devices (HMDs), personal digital assistants (PDAs), asset tracking devices, other handheld devices, netbooks, notebook computers, tablet computers, laptops, display devices (e.g., TVs, computer monitors, etc.), printers, IoT devices, asset tags, key fobs, vehicles, etc. The AP 105 and the wireless devices 110 may be WiFi, Bluetooth®, and/or UWB capable devices. While one AP 105 is illustrated, the WLAN network 100 may have multiple APs 105. Each of the wireless devices 110, which may also be referred to as mobile stations (MSs), mobile devices, access terminals (ATs), user equipment(s) (UE), wireless nodes, wireless devices, subscriber stations (SSs), or subscriber units, may associate and communicate with an AP 105 via a communication link 115. Each AP 105 has a geographic coverage area 125 such that wireless devices 110 within that area can typically communicate with the AP 105. The wireless devices 110 may be dispersed throughout the geographic coverage area 125. Each wireless device 110 may be stationary or mobile.

A wireless device 110 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) is used to connect APs 105 in an extended service set. A geographic coverage area 125 for an access point 105 may be divided into sectors making up a portion of the coverage area. The WLAN network 100 may include access points 105 of different types (e.g., metropolitan area, home network, etc.), with varying sizes of coverage areas and overlapping coverage areas for different technologies. In other examples, other wireless devices can communicate with the AP 105.

While the wireless devices 110 may communicate with each other through the AP 105 using communication links 115, each wireless device 110 may also communicate directly with one or more other wireless devices 110 via a direct wireless link 120. Two or more wireless devices 110 may communicate via a direct wireless link 120 when both wireless devices 110 are in the AP geographic coverage area 125 or when one or neither wireless device 110 is within the AP geographic coverage area 125. Examples of direct wireless links 120 may include WiFi Direct connections, connections established by using a WiFi Tunneled Direct Link Setup (TDLS) link, 5G-NR sidelink, PC5, UWB, Bluetooth®, and other P2P group connections. The wireless devices 110 in these examples may communicate according to the WLAN radio and baseband protocol including physical and MAC layers from IEEE 802.11 and IEEE 802.15, and their various versions. For example, the one or more of the wireless devices 110 and the AP 105 may be configured to utilize WiFi, Bluetooth®, and/or UWB signals for communications and/or positioning applications.

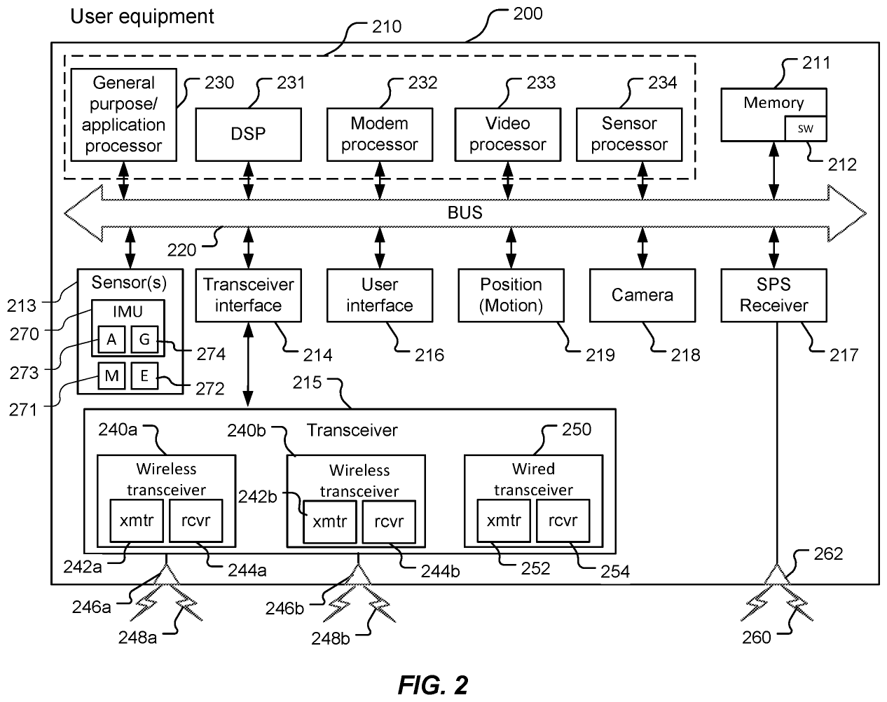

Referring also to FIG. 2, a UE 200 is an example of the wireless devices 110 and comprises a computing platform including a processor 210, memory 211 including software (SW) 212, one or more sensors 213, a transceiver interface 214 for a transceiver 215 (including one or more wireless transceivers such as a first wireless transceiver 240a, a second wireless transceiver 240b, and optionally a wired transceiver 250), a user interface 216, a Satellite Positioning System (SPS) receiver 217, a camera 218, and a position (motion) device 219. The processor 210, the memory 211, the sensor(s) 213, the transceiver interface 214, the user interface 216, the SPS receiver 217, the camera 218, and the position (motion) device 219 may be communicatively coupled to each other by a bus 220 (which may be configured, e.g., for optical and/or electrical communication). One or more of the shown apparatuses (e.g., the camera 218, the position (motion) device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for radio frequency (RF) sensing and ultrasound. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software (which may also include firmware) 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceivers 240a-b. Other example configurations include one or more of the processors 230-234 of the processor 210, the memory 211, the wireless transceivers 240a-b, and one or more of the sensor(s) 213, the user interface 216, the SPS receiver 217, the camera 218, the PMD 219, and/or the wired transceiver 250. Other configurations may not include all of the components of the UE 200. For example, an IoT device may include more wireless transceivers 240a-b, the memory 211 and a general-purpose processor 230. A multi-link device may simultaneously utilize the first wireless transceiver 240a on a first link using a first frequency band, and the second wireless transceiver 240b on a second link using a second frequency band. Additional transceivers may also be used for additional links and frequency bands and radio access technologies.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise one or more inertial sensors, for example, one or more accelerometers 273 (e.g., collectively responding to acceleration of the UE 200 in three dimensions) and/or one or more gyroscopes 274. The magnetometer(s) may provide measurements to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile. In another example, for relative positioning information, the sensors/IMU can be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) 271 may include a two-dimensional magnetometer configured to detect and provide indications of magnetic field strength in two orthogonal dimensions. Also or alternatively, the magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include wireless transceivers 240a-b and a wired transceiver 250 configured to communicate with other devices through wireless connections and wired connections, respectively. In an example, each of the wireless transceivers 240a-b may include respective transmitters 242a-b and receivers 244a-b coupled to one or more respective antennas 246a-b for transmitting and/or receiving wireless signals 248a-b and transducing signals from the wireless signals 248a-b to wired (e.g., electrical and/or optical) signals and from wired (e.g., electrical and/or optical) signals to the wireless signals 248a-b. Thus, the transmitters 242a-b may be the same transmitter, or may include multiple transmitters that may be discrete components or combined/integrated components, and/or the receivers 244a-b may be the same receiver, or may include multiple receivers that may be discrete components or combined/integrated components. The wireless transceivers 240a-b may be configured to communicate signals (e.g., with access points and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11ax and 802.11be), WiFi, WiFi Direct (WiFi-D), Bluetooth®, IEEE 802.15 (UWB), Zigbee etc. The wireless transceivers 240a-b may be configured to obtain signal strength measurements for RF signals associated with one or more RATS. The wired transceiver 250 may include a transmitter 252 and a receiver 254 configured for wired communication. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216. In an example, the user interface 216 may include one or more biometric sensors configured to obtain biometric information from a user. For example, the biometric sensors may include a fingerprint capture device, a microphone (for voice input), the camera 218 (e.g., for facial recognition, iris detection), a display (e.g., for finger swipe recognition) or other such sensors. The IMU 270 may be configured to obtain motion data to determine biometric information such as the user's gait or step length. Other sensors in the UE 200 may also be used to obtain biometric information from a user.

The SPS receiver 217 (e.g., a Global Positioning System (GPS) receiver) may be capable of receiving and acquiring SPS signals 260 via an SPS antenna 262. The antenna 262 is configured to transduce the SPS signals 260 to wired signals, e.g., electrical or optical signals, and may be integrated with one or more of the antennas 246a-b. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceivers 240a-b) for use in performing positioning operations. For example, the positioning operations may be based on RSSI measurements. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position (motion) device (PMD) 219 may be configured to determine a position and possibly motion of the UE 200. For example, the PMD 219 may communicate with, and/or include some or all of, the SPS receiver 217. The PMD 219 may also or alternatively be configured to determine location of the UE 200 using terrestrial-based signals (e.g., at least some of the wireless signals 248a-b) for trilateration or mulilateration, for assistance with obtaining and using the SPS signals 260, or both. The PMD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PMD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose processor 230 and/or the DSP 231) may be configured to use to determine motion (e.g., a velocity vector and/or an acceleration vector) of the UE 200. The PMD 219 may be configured to provide indications of uncertainty and/or error in the determined position and/or motion. In an example the PMD 219 may be referred to as a Positioning Engine (PE), and may be performed by the general-purpose processor 230. For example, the PMD 219 may be a logical entity and may be integrated with the general-purpose processor 230 and the memory 211.

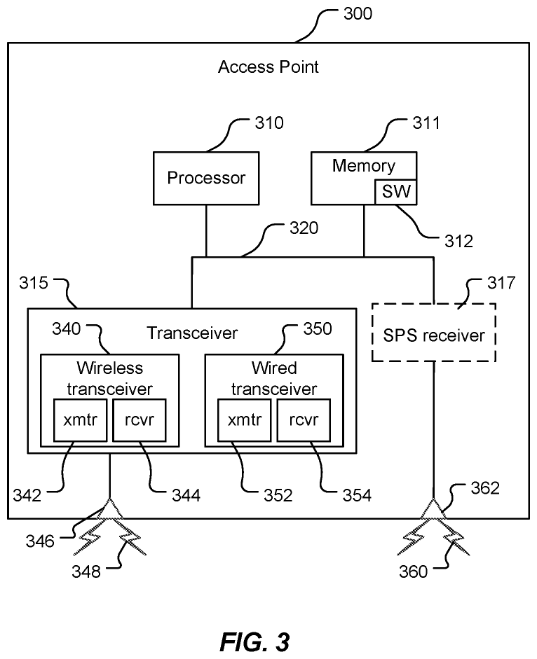

Referring also to FIG. 3, an example of an access point (AP) 300 such as the AP 105 comprises a computing platform including a processor 310, memory 311 including software (SW) 312, a transceiver 315, and (optionally) an SPS receiver 317. The processor 310, the memory 311, the transceiver 315, and the SPS receiver 317 may be communicatively coupled to each other by a bus 320 (which may be configured, e.g., for optical and/or electrical communication). One or more of the shown apparatuses (e.g., a wireless interface and/or the SPS receiver 317) may be omitted from the AP 300. In an example, the SPS receiver 317 may be configured similarly to the SPS receiver 217 to be capable of receiving and acquiring SPS signals 360 via an SPS antenna 362. Other configurations for sharing receive chains between the wireless transceiver and the SPS receiver 317 as described herein may also be used. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer to the processor 310 performing a function, but this includes other implementations such as where the processor 310 executes software and/or firmware. The description may refer to the processor 310 performing a function as shorthand for one or more of the processors contained in the processor 310 performing the function. The processor 310 may include a memory with stored instructions in addition to and/or instead of the memory 311. Functionality of the processor 310 is discussed more fully below.

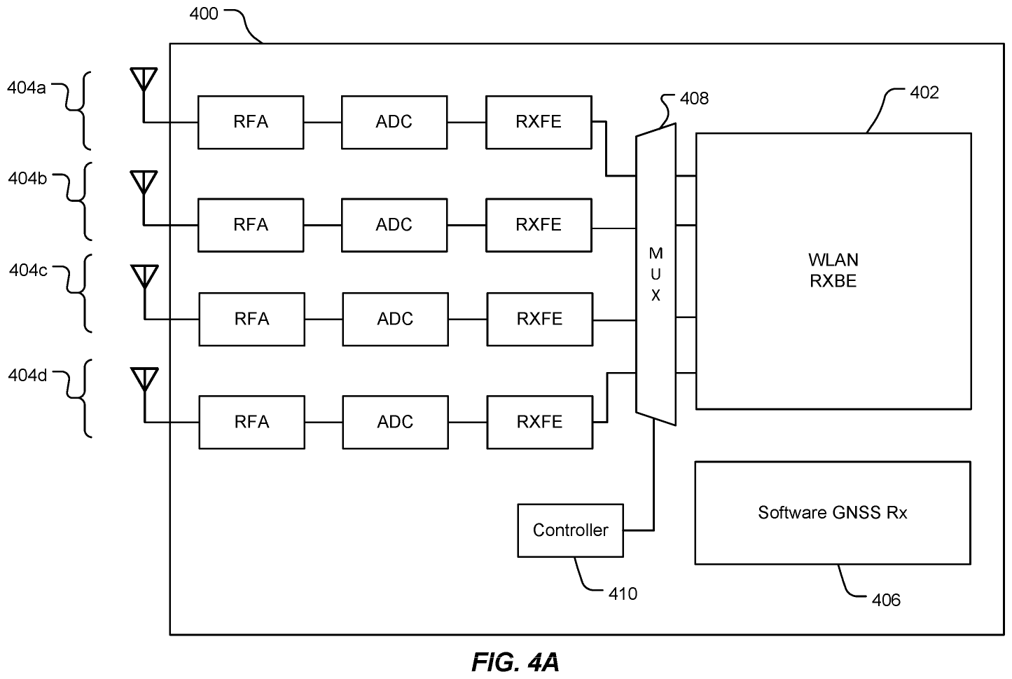

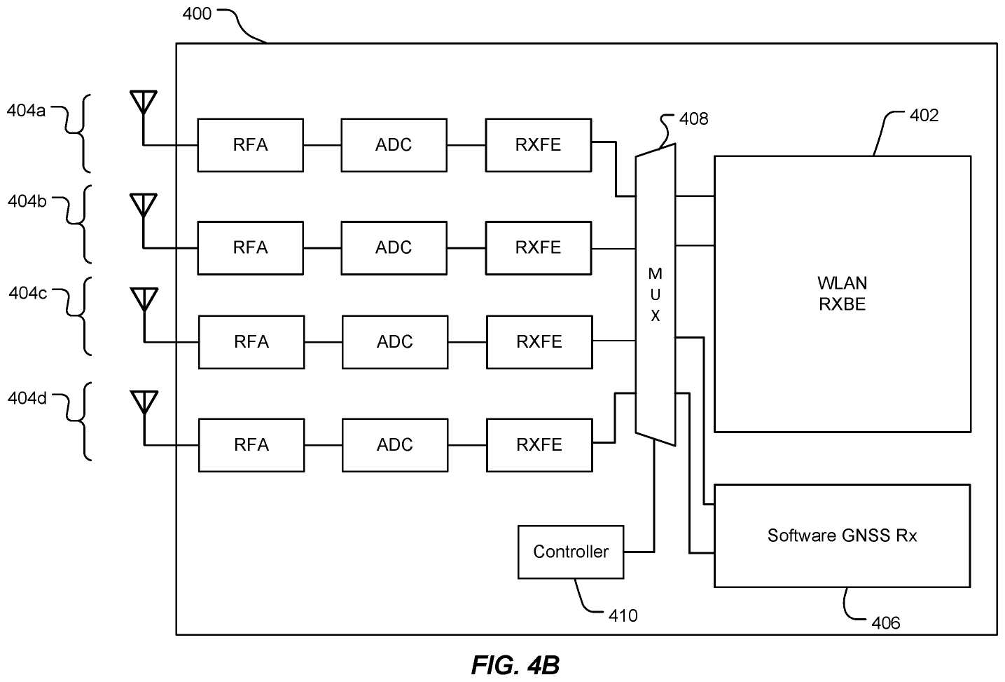

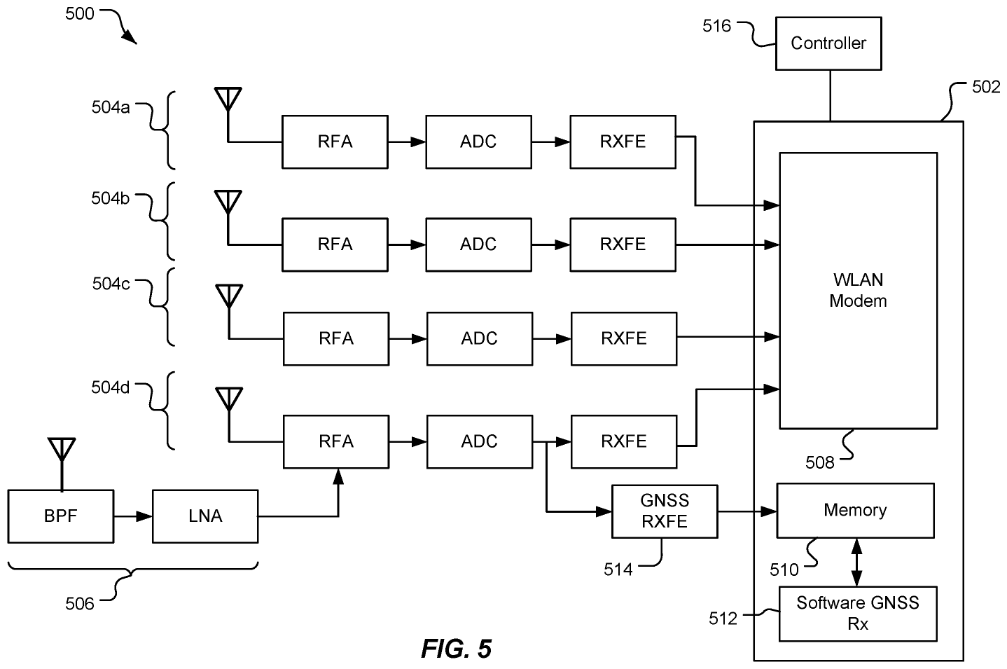

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels) and/or receiving (e.g., on one or more downlink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. As described in FIGS. 4A-FIG. 5, the receiver 344 may include a plurality of receive chains and antennas. The wireless transceiver 340 may be configured to communicate signals (e.g., with the UE 200, one or more other UEs, and/or one or more other devices) according to a variety of radio access technologies (RATs) such as IEEE 802.11 (including IEEE 802.11ax and 802.11be), WiFi, WiFi Direct (WiFi-D), Bluetooth®, IEEE 802.15 (UWB), Zigbee etc. The wired transceiver 350 may include a transmitter 352 and a receiver 354 configured for wired communication. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication.

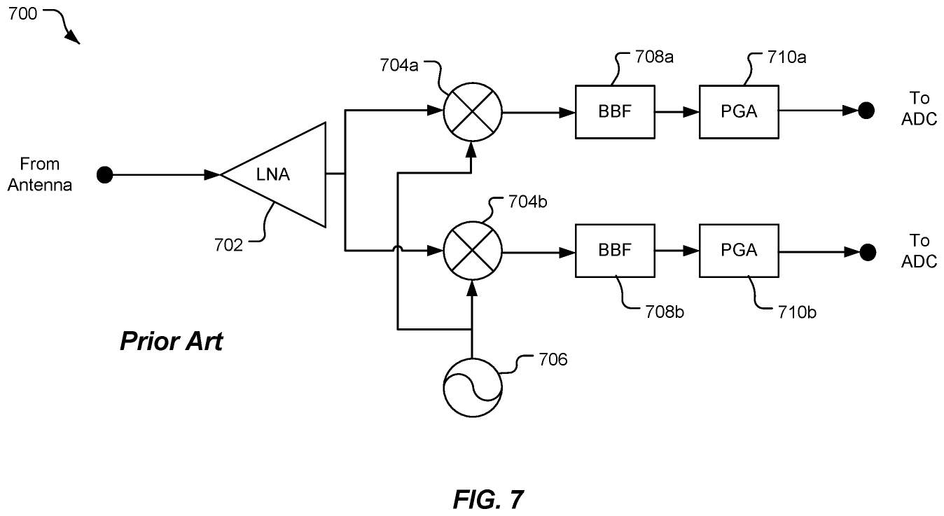

Referring to FIG. 4A, a block diagram of components of an example wireless node 400 with receive chains configured to operate with a wireless network is shown. The components of the wireless node 400 are an example of the receiver 344 in the access point 300. The components of the wireless node 400 include a receiver backend (RXBE) 402, a plurality of receive chains 404a, 404b, 404c, 404d configured to receive RF signals, one or more multiplexers 408, and a controller 410. In an example, the processor 310 may be configured as the controller 410. Other processing circuits may also be configured as the controller 410. The controller 410 may be configured to provide control signals to the one or more multiplexers 408. Each of the plurality of receive chains 404a-d includes radio frequency and analog (RFA) components, analog-to-digital (ADC) components, and receiver frontend (RXFE) components. Referring to FIG. 7, components of an example RFA 700 are shown. The RFA 700 includes a low-noise amplifier (LNA) 702, mixers 704a, 704b, a local oscillator 706, baseband filters (BBF) 708a, 708b, and programmable gain amplifiers (PGA) 710a, 710b. The RFA is configured to provide the analog RF signal to the ADC components. The RXBE 402 includes digital signal processing (DSP) components and processors (e.g., modems) configured to demodulate, and decode the signals received from the RXFE (e.g., the receive chains 404a-d via the one or more multiplexers 408). The RXBE 402 may also be configured to perform error correction and signal equalization processes.

In a first mode of operation, the one or more multiplexers 408 may be configured (e.g., via the controller 410) to provide signals on each of the receive chains 404a-d to the RXBE 402. For example, all of the resources in the wireless node 400 may be allocated for WLAN communications and each of the plurality of receive chains 404a-d may be utilized by the RXBE 402. In a second mode of operation, the wireless node 400 may be configured to obtain location measurements. Referring to FIG. 4B, one or more of the receive chains 404a-d may be utilized by a GNSS receiver 406 to obtain the location measurements. The functionality of the GNSS receiver 406 may be implemented in software executing on the wireless node 400 (e.g., the processor 310 and the memory 311 may be configured as the GNSS receiver 406). In an example, the wireless node 400 may include SPS receiver components, such as the SPS receiver 317. While the GNSS is in operation, the wireless node 400 may continue to perform WLAN communications with the receive chains that are not being utilized for GNSS operations. For example, the controller 410 may configure the one or more multiplexers 408 to utilize the first receive chain 404a and the second receive chain 404b for WLAN operations, while the third receive chain 404c and the fourth receive chain 404d are utilized for GNSS operations. When the GNSS measurements are complete, the controller 410 may configure the one or more multiplexers 408 to return the third and fourth receive chains 404c, 404d back to WLAN operations (e.g., as depicted in FIG. 4A).

In an example, the wireless node 400 and/or a coordinating server may determine when to configure one or more of the receive chains 404a-d for WLAN and/or GNSS operations based on operational requirements. For example, GNSS operations may be initiated based on a time of day, a date, network traffic information, historical information, network configuration information (e.g., changes to the network such as adding new nodes to a network and/or removing nodes from the network) or other quality of service requirements (e.g., latency, position estimate accuracy, etc.). The wireless node 400 and/or network server may proactively provide indications to network nodes (e.g., UEs, APs, etc.) of the reduced WLAN capabilities when sharing with GNSS is enabled. In an example, the wireless node 400 and/or network server may coordinate with neighboring stations to stagger reduced capabilities such that wireless nodes in the network may have an opportunity to change stations. The other wireless nodes in a network (e.g., non-GNSS enabled APs) may be configured to perform RTT ranging with the wireless node 400 after the GNSS operations are complete and a position estimate is computed.

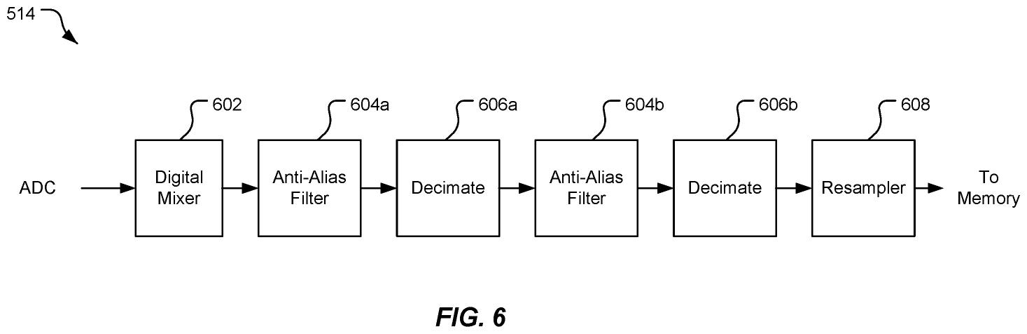

Referring to FIG. 5, a block diagram of components of an example wireless node 500 with at least one receive chain configure to operate with a wireless network and a global satellite navigation system. The components of the example wireless node 500 are an example of the receiver 344 in the access point 300. The components of the wireless node 500 include a RXBE 502 and a plurality of receive chains 504a, 504b, 504c, 504d configured to receive RF signals. The RXBE 502 may be communicatively coupled to a controller 516. In an example, the controller 516 may be the processor 310 in the AP 300. The receive chains 504a-d are communicatively coupled to the RXBE 502. In an example, the RXBE 502 includes a modem 508 configured to demodulate and decode the signals received from the respective RXFEs on the receive chains 504a-d. The wireless node 500 may include one or more GNSS antenna patches such as the GNSS antenna patch 506 communicatively coupled to an RFA in a receive chain. The GNSS antenna patch 506 may include antenna elements, band pass filters (BPF) and LNAs configured to receive GNSS signals from one or more satellite vehicles (e.g., L1, L2, L5 bands etc.). In an example, the output of the ADC in the receive chain may be communicatively coupled with a GNSS receiver frontend (RXFE) module 514 configured to filter and decimate signals output from the ADC in the fourth receive chain 504d. The GNSS RXFE module 514 may include a Front End Processor (FEP) configured to perform data formatting, synchronization and preliminary signal analysis. In an example, referring to FIG. 6, an example GNSS RXFE module 514 may include a digital mixer 602, anti-aliasing filters 604a, 604b, decimation filters 606a, 606b, and a resampler 608. The digital mixer 602 may be configured to combine or mix digital signals from different sources or different bands. In operation, the digital mixer may be implemented to perform carrier frequency and code phase tracking of signals received via the GNSS antenna patch 506. The anti-aliasing filters 604a, 604b are configured to reduce the impact of high-frequency signals that are incorrectly represented at lower frequencies due to under sampling in the ADC conversion (e.g., aliasing). The decimation filters 606a, 606b may be configured to reduce the sample rate of the digitized signal. The decimation filters 606a, 606b may include low-pass filtering of the digitize signal to remove unwanted high-frequency components. The resampler 608 may be configured to adjust the sampling rate of the digitized GNSS signals to match the requirements of the back-end components. For example, the digital signals may be stored in a memory 510 with an operational data transfer rate and bandwidth and the resampler 608 may be configured to provide the digital signals to meet those requirements. A software module 512 may be configured to process the GNSS signals stored in memory 510 to obtain location measurements. In an example, the processor 310 may be configured to process the GNSS signals in the memory 311.

The controller 516 may be configured to enable one or more of the receive chains 504a-d to receive GNSS signals. For example, in a first operation mode, the wireless node 500 may be configured to operate at full capacity, with each of the plurality of receive chains 504a-d configured for receiving network traffic. In a second operation mode, the wireless node 500 may be configured to obtain GNSS location measurements based on internal programming and/or signals received from an external resource (e.g., network server, neighboring station, mobile device, etc.). The host software may configure one or more receive chains 504a-d for GNSS operations. For example, the RFA/ADC/RXFE in the fourth receive chain 504d may be configured to enable reception and processing of GNSS signals with the GNSS antenna patch 506 and the GNSS RXFE module 514. The wireless node 500 may utilize the GNSS RX software (e.g., the software module 512) to process the GNSS signals and compute a position. During the GNSS operations, the wireless node 500 may operate at a reduced capability for network operations since fewer receive chains may be utilized for receiving network traffic. When the GNSS operations are complete, the host software may configure the receive chains 504a-d for full WLAN capability. One or more messages may be provided by the wireless node 500 and/or a network server to inform neighboring wireless nodes (e.g., APs, UEs, etc.) when the wireless node 500 is operating at full capacity or at reduced capacity. Uplink, downlink and/or sidelink communication protocols may be used to initiate GNSS operations and to inform neighboring stations of current and/or scheduled GNSS operations. In a WiFi example, Overlapping Master Neighbor (OMN) messages may be broadcasted by APs to request positioning and/or inform stations of the current or future capability status.

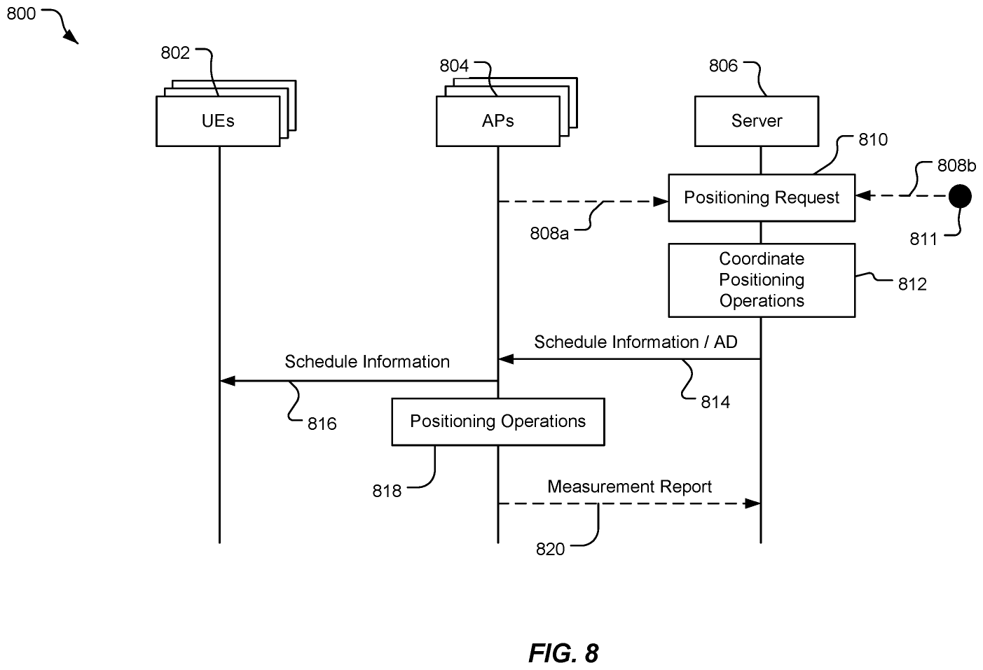

Referring to FIG. 8, an example message flow 800 for coordinating positioning operations in a wireless network is shown. The example message flow 800 may include a client device such as one or more UEs 802, one or more stations such as APs 804, and a server 806. The server 806 is an example of a network resource configured to assist with positioning operations. In an example, the server 806 may be a wireless device 110 or other wireless stations as described in FIG. 1. The APs 804 may have some or all of the components of the AP 300, and the AP 300 is an example of one or more of the APs 804. In an example, the server 806 may be one of the APs 804.

An AP and/or other network resource 811 may optionally be configured to send one or more respective positioning request messages 808a, 808b to initiate GNSS operations in one or more of the APs 804. At stage 810, the server 806 may receive a positioning request messages 808a, 808b from an external station. The positioning request messages 808a, 808b may be OMN messages, or may be included in other data packets transmitted between the network stations. In an example, the server 806 may be configured to initiate a positioning request based on time of date, date, traffic information, historical information, detection of new station configurations (e.g., addition, removal, relocation of an AP), or other network requirements. At stage 812, the server 806 may be configured to coordinate positioning operations with one or more of the APs 804. For example, the server 806 may configure staggered GNSS operations such that the APs 804 perform positioning operations serially. Other configurations may include performing GNSS operations with multiple APs 804 in parallel. Other positioning operations, such as RTT, RSSI, TDOA may be coordinated by the server 806 to enable non-GNSS enabled APs to benefit from the position updates obtained by the GNSS enabled APs (e.g., anchor stations). The server 806 may be configured to disseminate the schedule information to the APs 804 via one or more scheduling messages 814. The scheduling messages 814 may be OMN messages or included in other data packets sent to the APs 804 (e.g., via a wired backhaul, via over-the-air messages, etc.). In an example, the scheduling messages 814 may include assistance data (e.g., GNSS ephemeris data) to assist the APs 804 in computing a location based on receiving GNSS signals. In an example, the APs 804 may inform network stations (e.g., client devices, neighboring APs, etc.), such as the UEs 802, of the scheduled operations via local scheduling messages 816. The local scheduling messages 816 may include an indication of one or more time periods when one or more neighboring network stations are to perform navigation operations. The local schedule messages may be used to stagger navigation operations to reduce the impact on service provided to client devices in the network. The local scheduling messages 816 may be OMN messages, or may utilize other signaling techniques as known in the art.

At stage 818, one or more of the APs 804 may be configured to perform positioning operations, such as described in FIG. 4B and FIG. 5. One or more of the receive chains in the APs 804 may be utilized for GNSS operations and thus the network capabilities of the APs 804 may be reduced. The local scheduling messages 816 may provide an opportunity for the UEs 802 to change from a reduced capability AP to a full capability AP to maintain a desired quality of service. In an example, a decision to perform GNSS operations may be based on the available processing capability of one or more of the APs. The available processing capability may be based on a processing unit (e.g., the processor 310, or other processing unit) utilization value being below a threshold level (e.g., 40%, 60%, 80%, etc.). Other processing metrics, such as the current number of active processes and/or threads may be compared to threshold values. In an example, the number of UEs 802 communicating with an AP may be used to determine the available processing capability (e.g., the number of active UEs being below a threshold value). The APs 804 may be configured to utilize the software module 512 to compute a location based on the received GNSS signals. In an example, the APs 804 may optionally be configured to send one or more measurement report messages 820 with GNSS signal information, and the server 806 may be configured to compute position estimates based on the measurement report messages 820. The server 806 may provide the position estimate back to the AP 804. The measurement report messages 820 may include measurements obtained by non-GNSS enabled APs, such as RTT, RSSI, TDOA, and other ranging signal measurements.

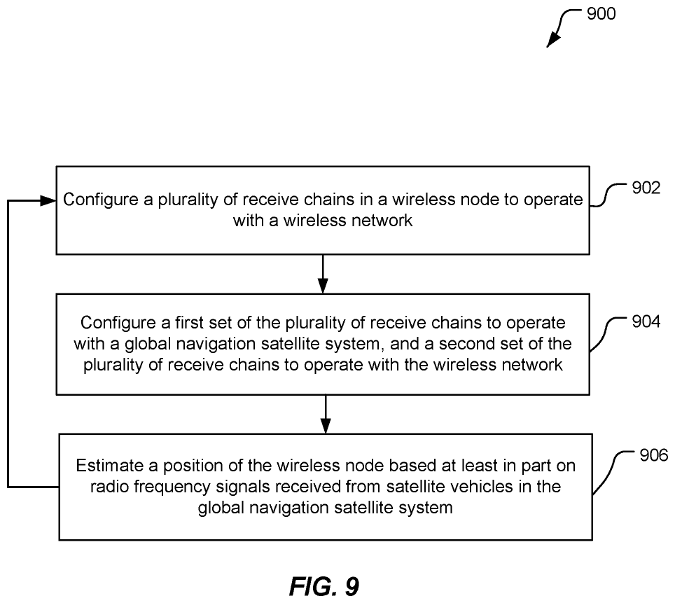

Referring to FIG. 9, with further reference to FIGS. 1-8, a method 900 for configuring receive chains in a wireless node includes the stages shown. The method 900 is, however, an example and not limiting. The method 900 may be altered, e.g., by having stages added, removed, rearranged, combined, performed concurrently, and/or having single stages split into multiple stages.

At stage 902, the method includes configuring a plurality of receive chains in a wireless node to operate with a wireless network. An AP 300, including the processor 310 and the receiver 344 is a means for configuring the plurality of receive chains. In an example, the receiver 344 may include some or all of the components of the wireless node 500. The plurality of receive chains 504a-d may be configured for WLAN operations for receiving signals from network stations. The controller 516 may provide instructions to the RXBE 502 to utilize the signals on each of the plurality of receive chains 504a-d.

At stage 904, the method includes configuring a first set of the plurality of receive chains to operate with a global navigation satellite system, and a second set of the plurality of receive chains to operate with the wireless network. The AP 300, including the processor 310 and the receiver 344 is a means for configuring the plurality of receive chains. In an example, the AP 300 may receive an indication from an external resource (e.g., the server 806) to perform GNSS operations. For example, the AP 300 may receive one or more scheduling messages 814 indicating one or more time periods to configure the first set of receive chains for GNSS operations. In an example, the AP 300 may be configured to schedule the GNSS operations. The controller 516 may configure one or more of the receive chains 504a-d to process received GNSS signals. Referring to FIG. 5, the first set of receive chains may be the fourth receive chain 504d configured to receive the signals received by the GNSS antenna patch 506 and provide a digital signal to the GNSS RXFE module 514. The second set of receive chains may include a first receive chain 504a, a second receive chain 504b, and a third receive chain 504c. Other hardware configurations and receive chains may be included in the first and second set of receive chains.

At stage 906, the method includes estimating a position of the wireless node based at least in part on radio frequency signals received from satellite vehicles in the global navigation satellite system. The AP 300, including the processor 310 and the memory 311 is a means for estimating the position of the wireless node. In an example, the software module 512 may be configured as an extended Kalman filter (e.g., also referred to as a navigation filter). Information associated with navigation satellites in a navigation filter typically includes satellite clock offset and drift, orbital parameters, carrier wave integer ambiguity estimates, solar radiation pressure parameters, biases of the monitoring stations clock, tropospheric effects, and earth rotational components. The satellite information may be stored in a local memory (e.g., the memory 510) and/or received from a network resource (e.g., included in assistance data messages). The software module 512 and the processor 310 may be configured to process location assistance information comprising updated GNSS satellite almanac and/or ephemeris information, which may then be used with the signals received by the fourth receive chain 504d and stored in the memory 510 to estimate the position. The method 900 may iterate back to stage 902 such that full WLAN capabilities are restored until subsequent positioning information is required.

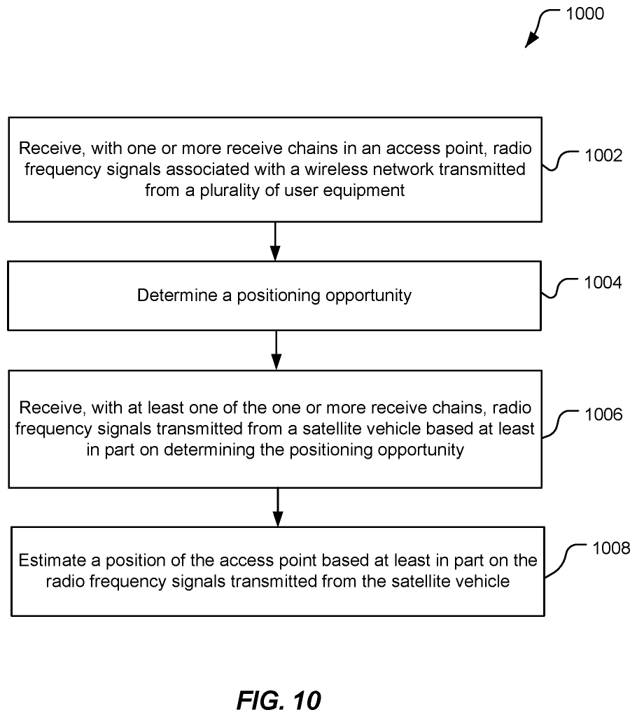

Referring to FIG. 10, with further reference to FIGS. 1-8, a method 1000 for obtaining a position estimate with an access point includes the stages shown. The method 1000 is, however, an example and not limiting. The method 1000 may be altered, e.g., by having stages added, removed, rearranged, combined, performed concurrently, and/or having single stages split into multiple stages.

At stage 1002, the method includes receiving, with one or more receive chains in an access point, radio frequency signals associated with a wireless network transmitted from a plurality of user equipment. An AP 300, including the processor 310 and the receiver 344 is a means for receiving the RF signals transmitted from the at plurality of UEs. In an example, referring to FIG. 5, the wireless node 500 may be configured to receive network RF signals (e.g., WiFi, Sidelink, etc.) from other network stations (i.e., wireless devices) in a wireless network. The one or more receive chains may include one or more of the receive chains 504a-d. The plurality of UEs may include, for example, UEs, APs, and/or other wireless devices 110 as described in FIG. 1.

At stage 1004, the method includes determining a positioning opportunity. The AP 300, including the processor 310 and the receiver 344 is a means for determining the positioning opportunity. In an example, the positioning opportunity may be based on receiving a positioning request from a network station via an OMN message, or scheduling messages from a network server. In an example, the positioning opportunity may be initiated based on a time of day, a date, network traffic information, historical information, network configuration information (e.g., changes to the network such as adding new nodes to a network and/or removing nodes from the network) or other quality of service requirements (e.g., latency, position estimate accuracy, etc.). In an example, the positioning opportunity may be based at least in part on an available processing capability of the access point. The AP 300 may be configured to determine whether processor 310, or other processing unit, have the computational resources available to run software defined GNSS. The computational resources may be impacted by operational factors such as the applications running on the AP 300, the number of connected devices, the availability of nearby APs or network congestion, the actual AP or network congestion, or the number of devices connected to and/or utilizing the AP. In an example, the available computational resources/processing capability may be determined based on a current processing unit utilization value or other processing metrics such as a current number of active processes and/or threads. Other network information, such as current number of wireless nodes (e.g., UEs, APs, etc.) that are communicating with the AP, may be used to determine the available processing capability. Determining the available processing capability may include comparing such processing metrics to previously determined threshold values. Other techniques may be used to enable the AP to opportunistically utilize one or more of the receive chains and processing capabilities to perform GNSS operations.

At stage 1006, the method includes receiving, with at least one of the one or more receive chains, radio frequency signals transmitted from a satellite vehicle based at least in part on determining the positioning opportunity. The AP 300, including the processor 310 and the receiver 344 is a means for receiving the RF signals transmitted from a satellite vehicle. The AP 300 may be configured to opportunistically perform software-defined GNSS operations based on the computational resources available to the AP 300 (e.g., the applications running on the AP 300, the number of connected devices, the availability of nearby APs or network congestion, the actual AP or network congestion, or the number of devices connected to and/or utilizing the AP). The AP 300 may be configured to determine when the available computational resources are available and/or sufficiently high enough to handle the additional processing requirements for processing GNSS signals. For example, the GNSS operations may proceed when the processing unit utilization level is below a threshold amount (e.g., 40%, 60%, 80%, etc.). The controller 516 may configure one or more of the receive chains 504a-d to process received GNSS signals in response to determining the positioning opportunity when the available processing capability is determined at stage 1004. Referring to FIG. 5, the at least one of the one or more receive chains may be the fourth receive chain 504d in the wireless node 500. The fourth receive chain 504d may be configured to receive the signals transmitted from the satellite via the GNSS antenna patch 506 and provide a digital signal to the GNSS RXFE module 514. Other receive chains may also be configured with a GNSS patch antenna and GNSS RXFE module 514 to obtain satellite signals. In an example, referring to FIGS. 4A and 4B, one or more multiplexers 408 may be configured to provide received satellite signals to the software GNSS receiver 406.

At stage 1008, the method includes estimating a position of the access point based at least in part on the radio frequency signals transmitted from the satellite vehicle. The AP 300, including the processor 310 and the memory 311 is a means for estimating the position of the access point. In an example, the software module 512 in the access point may be configured as a navigation filter (e.g., an extended Kalman filter). Information associated with radio frequency signals transmitted from the satellite vehicle (and other satellites) stored in the navigation filter may include satellite clock offset and drift, orbital parameters, carrier wave integer ambiguity estimates, solar radiation pressure parameters, biases of the monitoring stations clock, tropospheric effects, and earth rotational components. The satellite information may be stored in memory 510 and/or received from a network resource (e.g., included in assistance data messages). The software module 512 and the processor 310 may be configured to process location assistance information comprising updated GNSS satellite almanac and/or ephemeris information, which may then be used with the signals received a stage 1004 and stored in the memory 510 to estimate the position.

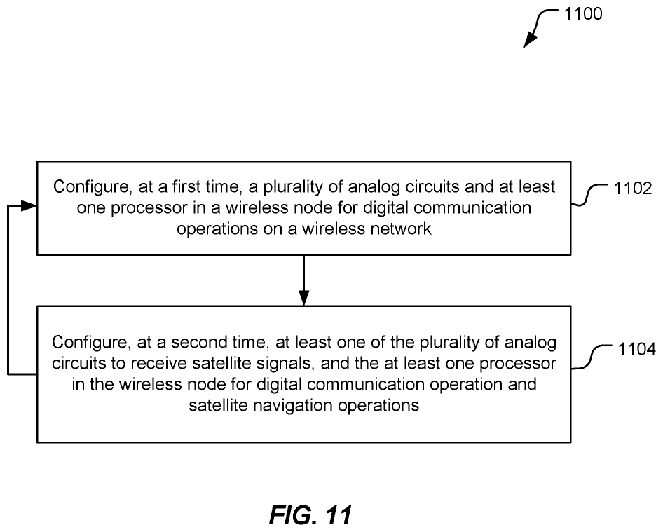

Referring to FIG. 11, with further reference to FIGS. 1-8, a method 1100 for configuring a wireless node for network communication and satellite navigation operations includes the stages shown. The method 1100 is, however, an example and not limiting. The method 1100 may be altered, e.g., by having stages added, removed, rearranged, combined, performed concurrently, and/or having single stages split into multiple stages.

At stage 1102, the method includes configuring, at a first time, a plurality of analog circuits and at least one processor in a wireless node for digital communication operations on a wireless network. An AP 300, including the processor 310 and the receiver 344 is a means for configuring the analog circuits and the at least one processor. In an example, referring to FIG. 5, the wireless node 500 may include the controller 516, the RXBE 502, and the plurality of receive chains 504a, 504b, 504c, 504d configured to receive RF signals. The plurality of analog circuits may be the plurality of receive chains 504a, 504b, 504c, 504d. The at least one processor may be the processor 310 (e.g., the controller 516). In operation, the wireless node may be configured to receive network RF signals (e.g., WiFi, Sidelink, etc.) from other network stations (i.e., wireless devices) in the wireless network.

At stage 1104, the method includes configuring, at a second time, at least one of the plurality of analog circuits to receive satellite signals, and the at least one processor in the wireless node for digital communication operation and satellite navigation operations. The AP 300, including the processor 310 and the receiver 344 is a means for configuring at least one of the plurality of analog circuits to receive satellite signals, and the at least one processor in the wireless node for digital communication operation and satellite navigation operations. In an example, the AP 300 may be configured to perform GNSS operations based on internal (e.g., applications running locally on the AP 300), and/or based on external requests from an external resource (e.g., the server 806). The processor 310 (e.g., the controller 516) may configure one or more of the receive chains 504a-d to process received GNSS signals and to process the GNSS signals to obtain a location estimate. Referring to FIG. 5, the at least one of the plurality of receive chains may be the fourth receive chain 504d in the wireless node 500. The fourth receive chain 504d may be configured to receive the signals transmitted from the satellite via the GNSS antenna patch 506 and provide a digital signal to the GNSS RXFE module 514. Other receive chains may also be configured with a GNSS patch antenna and GNSS RXFE module 514 to obtain satellite signals. The processor 310 and the software 312 (e.g., the software module 512) in the wireless node may be configured as a navigation filter (e.g., an extended Kalman filter). Information associated with radio frequency signals transmitted from the satellite vehicle (and other satellites) stored in the navigation filter may include satellite clock offset and drift, orbital parameters, carrier wave integer ambiguity estimates, solar radiation pressure parameters, biases of the monitoring stations clock, tropospheric effects, and earth rotational components. The satellite information may be stored in memory 311 and/or received from a network resource (e.g., included in assistance data messages). The processor 310 may be configured to process location assistance information comprising updated GNSS satellite almanac and/or ephemeris information, which may then be used with received GNSS signals to estimate a position.

The method 1100 may iterate back to stage 1102 after a positioning session is completed to fully utilize the plurality of analog circuits chains for digital communications on the network. The process 1100 enables the analog circuits and processing capabilities to be used for both digital communications and satellite navigation. This dual functionality may eliminate the need for a dedicated GNSS receiver and thus may reduce the cost of a wireless node for applications when occasional satellite based positions are required.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations. Components, functional or otherwise, shown in the figures and/or discussed herein as being connected or communicating with each other are communicatively coupled unless otherwise noted. That is, they may be directly or indirectly connected to enable communication between them.

As used herein, the singular forms “a,” “an,” and “the” include the plural forms as well, unless the context clearly indicates otherwise. For example, “a processor” may include one processor or multiple processors. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

As used herein, unless otherwise stated, a statement that a function or operation is “based on” an item or condition means that the function or operation is based on the stated item or condition and may be based on one or more items and/or conditions in addition to the stated item or condition.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of A or B or C″ means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure). Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or even primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements without departing from the scope of the disclosure.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

Clause 1. A method for configuring receive chains in a wireless node, comprising: configuring a plurality of receive chains in the wireless node to operate with a wireless network; configuring a first set of the plurality of receive chains to operate with a global navigation satellite system, and a second set of the plurality of receive chains to operate with the wireless network; and estimating a position of the wireless node based at least in part on radio frequency signals received from satellite vehicles in the global navigation satellite system.

Clause 2. The method of clause 1, further comprising receiving an indication from a network resource to perform navigation operations, wherein configuring the first set of the plurality of receive chains to operate with the global navigation satellite system is based at least in part on the indication.

Clause 3. The method of clause 2, wherein the indication includes one or more time periods.

Clause 4. The method of clause 2, wherein the indication is included in one or more overlapping master neighbor (OMN) messages.

Clause 5. The method of clause 1, wherein configuring the first set of the plurality of receive chains to operate with the global navigation satellite system is based at least in part on one or more of a time of day, network traffic information, historical information, network configuration information, and combinations thereof.

Clause 6. The method of clause 1, further comprising transmitting schedule information to one or more network stations, wherein the schedule information corresponds to a time period when the first set of the plurality of receive chains is configured to operate with the global navigation satellite system.

Clause 7. The method of clause 1, further comprising transmitting schedule information to one or more network stations, wherein the schedule information corresponds to a time period when one or more neighboring network stations are to perform navigation operations.

Clause 8. The method of clause 1, further comprising: providing one or more measurement reports to a network resource, wherein the one or more measurement reports are based at least in part on radio frequency signals received from satellite vehicles in the global navigation satellite system; and estimating the position of the wireless node based on a position information provided by the network resource.

Clause 9. The method of clause 1, wherein configuring the first set of the plurality of receive chains to operate with the global navigation satellite system includes coupling an antenna patch to at least one receive chain in the first set of the plurality of receive chains.

Clause 10. A method for obtaining a position estimate with a wireless node, comprising: receiving radio frequency signals transmitted from at least one network station with a plurality of receive chains in the wireless node; receiving radio frequency signals transmitted from a satellite vehicle with at least one of the plurality of receive chains in the wireless node; and estimating a position of the wireless node based at least in part on the radio frequency signals transmitted from the satellite vehicle.

Clause 11. The method of clause 10, further comprising receiving an indication from a network resource to perform navigation operations, wherein receiving radio frequency signals transmitted from the satellite vehicle with at least one of the plurality of receive chains is based at least in part on the indication.

Clause 12. The method of clause 11, wherein the indication includes one or more time periods.

Clause 13. The method of clause 11, wherein the indication is included in one or more overlapping master neighbor (OMN) messages.

Clause 14. The method of clause 10, wherein receiving radio frequency signals transmitted from the satellite vehicle with at least one of the plurality of receive chains is based at least in part on one or more of a time of day, network traffic information, historical information, network configuration information, and combinations thereof.

Clause 15. The method of clause 10, further comprising transmitting schedule information to the at least one network station, wherein the schedule information corresponds to a time period when the wireless node is configured to receive radio frequency signals transmitted from the satellite vehicle.

Clause 16. The method of clause 10, further comprising transmitting schedule information to the at least one network station, wherein the schedule information corresponds to a time period when the at least one network station is to perform navigation operations.

Clause 17. The method of clause 10, further comprising: providing one or more measurement reports to a network resource, wherein the one or more measurement reports are based at least in part on the radio frequency signals transmitted from the satellite vehicle; and estimating the position of the wireless node based on position information provided by the network resource.

Clause 18. The method of clause 10, wherein receiving radio frequency signals transmitted from the satellite vehicle with at least one of the plurality of receive chains includes coupling an antenna patch to the least one of the plurality of receive chains.

Clause 19. A method for configuring a wireless node for network communication and satellite navigation operations, comprising: configuring, at a first time, a plurality of analog circuits and at least one processor in the wireless node for digital communication operations on a wireless network; and configuring, at a second time, at least one of the plurality of analog circuits to receive satellite signals, and the at least one processor in the wireless node for digital communication operation and satellite navigation operations.

Clause 20. The method of clause 19, further comprising receiving an indication from a network resource to perform satellite navigation operations.

Clause 21. The method of clause 20, wherein the indication is included in one or more overlapping master neighbor (OMN) messages.

Clause 22. The method of clause 19, wherein the second time is based at least in part on one or more of a time of day, network traffic information, historical information, network configuration information, and combinations thereof.

Clause 23. The method of clause 19, further comprising estimating a position of the wireless node based at least in part on the satellite signals.

Clause 24. An apparatus, comprising: at least one memory; a plurality of receive chains communicatively coupled to at least one transceiver; at least one processor communicatively coupled to the at least one memory and the at least one transceiver, and configured to: receive, at a first time, digital communication radio frequency signals with each of the plurality of receive chains; and receive, at a second time, both satellite navigation radio frequency signals with one or more of the plurality of receive chains and the digital communication radio frequency signals with one or more of the plurality of receive chains.

Clause 25. The apparatus of clause 24, wherein the at least one processor is further configured to determine a position estimate based at least in part on the satellite navigation radio frequency signals.

Clause 26. The apparatus of clause 24, wherein the at least one processor is further configured to receive an indication from a network resource to perform satellite navigation operations.

Clause 27. The apparatus of clause 26, wherein the indication is included in one or more overlapping master neighbor (OMN) messages.

Clause 28. The apparatus of clause 24, wherein the second time is based at least in part on one or more of a time of day, network traffic information, historical information, network configuration information, and combinations thereof.

Clause 29. An apparatus, comprising: at least one memory; a plurality of receive chains communicatively coupled to at least one transceiver; at least one processor communicatively coupled to the at least one memory and the at least one transceiver, and configured to: configure the plurality of receive chains to operate with a wireless network; configure a first set of the plurality of receive chains to operate with a global navigation satellite system, and a second set of the plurality of receive chains to operate with the wireless network; and estimate a position based at least in part on radio frequency signals received from satellite vehicles in the global navigation satellite system.

Clause 30. The apparatus of clause 29, wherein the at least one processor is further configured to: receive an indication from a network resource to perform navigation operations; and configure the first set of the plurality of receive chains to operate with the global navigation satellite system based at least in part on the indication.

Clause 31. The apparatus of clause 30, wherein the indication includes one or more time periods.

Clause 32. The apparatus of clause 31, wherein the indication is included in one or more overlapping master neighbor (OMN) messages.

Clause 33. The apparatus of clause 29, wherein the at least one processor is further configured to configure the first set of the plurality of receive chains to operate with the global navigation satellite system based at least in part on one or more of a time of day, network traffic information, historical information, network configuration information, and combinations thereof.

Clause 34. The apparatus of clause 29, wherein the at least one processor is further configured to transmit schedule information to one or more network stations, wherein the schedule information corresponds to a time period when the first set of the plurality of receive chains is configured to operate with the global navigation satellite system.

Clause 35. The apparatus of clause 29, wherein the at least one processor is further configured to transmit schedule information to one or more network stations, wherein the schedule information corresponds to a time period when one or more neighboring network stations are to perform navigation operations.

Clause 36. The apparatus of clause 29, wherein the at least one processor is further configured to: provide one or more measurement reports to a network resource, wherein the one or more measurement reports are based at least in part on radio frequency signals received from satellite vehicles in the global navigation satellite system; and estimate the position based on a position information provided by the network resource.

Clause 37. The apparatus of clause 29, wherein the at least one processor is further configured to couple an antenna patch to at least one receive chain in the first set of the plurality of receive chains to configure the first set of the plurality of receive chains to operate with the global navigation satellite system.

Clause 38. An apparatus, comprising: at least one memory; a plurality of receive chains communicatively coupled to at least one transceiver; at least one processor communicatively coupled to the at least one memory and the at least one transceiver, and configured to: receive radio frequency signals transmitted from at least one network station with the plurality of receive chains; receive radio frequency signals transmitted from a satellite vehicle with at least one of the plurality of receive chains; and estimate a position based at least in part on the radio frequency signals transmitted from the satellite vehicle.

Clause 39. The apparatus of clause 38, wherein the at least one processor is further configured to: receive an indication from a network resource to perform navigation operations; and receive radio frequency signals transmitted from the satellite vehicle with at least one of the plurality of receive chains based at least in part on the indication.

Clause 40. The apparatus of clause 39, wherein the indication includes one or more time periods.

Clause 41. The apparatus of clause 39, wherein the indication is included in one or more overlapping master neighbor (OMN) messages.

Clause 42. The apparatus of clause 38, wherein the at least one processor is further configured to receive radio frequency signals transmitted from the satellite vehicle with at least one of the plurality of receive chains based at least in part on one or more of a time of day, network traffic information, historical information, network configuration information, and combinations thereof.

Clause 43. The apparatus of clause 38, wherein the at least one processor is further configured to transmit schedule information to the at least one network station, wherein the schedule information corresponds to a time period when the radio frequency signals transmitted from the satellite vehicle are to be received.

Clause 44. The apparatus of clause 38, wherein the at least one processor is further configured to transmit schedule information to the at least one network station, wherein the schedule information corresponds to a time period when the at least one network station is to perform navigation operations.

Clause 45. The apparatus of clause 38, wherein the at least one processor is further configured to: provide one or more measurement reports to a network resource, wherein the one or more measurement reports are based at least in part on the radio frequency signals transmitted from the satellite vehicle; and estimate the position based on position information provided by the network resource.

Clause 46. The apparatus of clause 38, wherein the at least one processor is further configured to couple an antenna patch to the least one of the plurality of receive chains to receive the radio frequency signals transmitted from the satellite vehicle with at least one of the plurality of receive chains.

Clause 47. An apparatus for configuring receive chains in a wireless node, comprising: means for configuring a plurality of receive chains in the wireless node to operate with a wireless network; means for configuring a first set of the plurality of receive chains to operate with a global navigation satellite system, and a second set of the plurality of receive chains to operate with the wireless network; and means for estimating a position of the wireless node based at least in part on radio frequency signals received from satellite vehicles in the global navigation satellite system.

Clause 48. An apparatus for obtaining a position estimate with a wireless node, comprising: means for receiving radio frequency signals transmitted from at least one network station with a plurality of receive chains in the wireless node; means for receiving radio frequency signals transmitted from a satellite vehicle with at least one of the plurality of receive chains in the wireless node; and means for estimating a position of the wireless node based at least in part on the radio frequency signals transmitted from the satellite vehicle.

Clause 49. An apparatus for configuring a wireless node for network communication and satellite navigation operations, comprising: means for configuring, at a first time, a plurality of analog circuits and at least one processor in the wireless node for digital communication operations on a wireless network; and means for configuring, at a second time, at least one of the plurality of analog circuits to receive satellite signals, and the at least one processor in the wireless node for digital communication operation and satellite navigation operations.

Clause 50. A non-transitory processor-readable storage medium comprising processor-readable instructions configured to cause one or more processors to configure receive chains in a wireless node, comprising code for: configuring a plurality of receive chains in the wireless node to operate with a wireless network; configuring a first set of the plurality of receive chains to operate with a global navigation satellite system, and a second set of the plurality of receive chains to operate with the wireless network; and estimating a position of the wireless node based at least in part on radio frequency signals received from satellite vehicles in the global navigation satellite system.

Clause 51. A non-transitory processor-readable storage medium comprising processor-readable instructions configured to cause one or more processors to obtain a position estimate with a wireless node, comprising code for: receiving radio frequency signals transmitted from at least one network station with a plurality of receive chains in the wireless node; receiving radio frequency signals transmitted from a satellite vehicle with at least one of the plurality of receive chains in the wireless node; and estimating a position of the wireless node based at least in part on the radio frequency signals transmitted from the satellite vehicle.

Clause 52. A non-transitory processor-readable storage medium comprising processor-readable instructions configured to cause one or more processors to configure a wireless node for network communication and satellite navigation operations, comprising code for: configuring, at a first time, a plurality of analog circuits and at least one processor in the wireless node for digital communication operations on a wireless network; and configuring, at a second time, at least one of the plurality of analog circuits to receive satellite signals, and the at least one processor in the wireless node for digital communication operation and satellite navigation operations.

Clause 53. A method for obtaining a position estimate with an access point, comprising: receiving, with one or more receive chains in the access point, radio frequency signals associated with a wireless network transmitted from a plurality of user equipment; determining a positioning opportunity; receiving, with at least one of the one or more receive chains, radio frequency signals transmitted from a satellite vehicle based at least in part on determining the positioning opportunity; and estimating a position of the access point based at least in part on the radio frequency signals transmitted from the satellite vehicle.

Clause 54. The method of clause 53, wherein determining the positioning opportunity includes receiving an indication from a network resource to perform navigation operations, wherein receiving radio frequency signals transmitted from the satellite vehicle with at least one of the one or more receive chains is based at least in part on the indication.

Clause 55. The method of clause 54, wherein the indication includes one or more time periods.

Clause 56. The method of clause 54, wherein the indication is included in one or more overlapping master neighbor (OMN) messages.

Clause 57. The method of clause 53, wherein determining the positioning opportunity is based at least in part on one or more of a time of day, network traffic information, historical information, network configuration information, and combinations thereof.

Clause 58. The method of clause 53, wherein determining the positioning opportunity is based at least in part on an available processing capability of the access point.

Clause 59. The method of clause 58, wherein the determining the available processing capability of the access point is based on a processing unit utilization level being below a threshold value.

Clause 60. The method of clause 58, wherein the determining the available processing capability of the access point is based on a number of user equipment in the plurality of user equipment being below a threshold.

Clause 61. The method of clause 53, further comprising transmitting schedule information to the plurality of user equipment, wherein the schedule information corresponds to a time period when the access point is configured to receive radio frequency signals transmitted from the satellite vehicle.

Clause 62. The method of clause 53, wherein receiving radio frequency signals transmitted from the satellite vehicle with at least one of the one or more receive chains includes coupling an antenna patch to the least one of the one or more receive chains.

Clause 63. An apparatus, comprising: at least one memory; a plurality of receive chains communicatively coupled to at least one transceiver; at least one processor communicatively coupled to the at least one memory and the at least one transceiver, and configured to: receive, with the plurality of receive chains, radio frequency signals associated with a wireless network transmitted from a plurality of user equipment; determine a positioning opportunity; receive, with at least one of the plurality of receive chains, radio frequency signals transmitted from a satellite vehicle based at least in part on determining the positioning opportunity; and estimate a position based at least in part on the radio frequency signals transmitted from the satellite vehicle.

Clause 64. The apparatus of clause 63, wherein the at least one processor is further configured to receive an indication from a network resource to perform navigation operations to determine the positioning opportunity, and to receive radio frequency signals transmitted from the satellite vehicle with at least one of the plurality of receive chains based at least in part on the indication.

Clause 65. The apparatus of clause 64, wherein the indication includes one or more time periods.

Clause 66. The apparatus of clause 64, wherein the indication is included in one or more overlapping master neighbor (OMN) messages.

Clause 67. The apparatus of clause 63, wherein the at least one processor is further configured to determine the positioning opportunity based at least in part on one or more of a time of day, network traffic information, historical information, network configuration information, and combinations thereof.

Clause 68. The apparatus of clause 63, wherein the at least one processor is further configured to determine the positioning opportunity based at least in part on an available processing capability.

Clause 69. The apparatus of clause 68, wherein the at least one processor is further configured to determine the available processing capability based on a processing unit utilization level being below a threshold value.

Clause 70. The apparatus of clause 68, wherein the at least one processor is further configured to determine the available processing capability based on a number of user equipment in the plurality of user equipment being below a threshold.

Clause 71. The apparatus of clause 63, wherein the at least one processor is further configured to transmit schedule information to the plurality of user equipment, wherein the schedule information corresponds to a time period when the radio frequency signals transmitted from the satellite vehicle will be received.

Clause 72. The apparatus of clause 63, wherein the at least one processor is further configured to couple an antenna patch to the least one of the plurality of receive chains.

Clause 73. An apparatus for obtaining a position estimate with an access point, comprising: means for receiving, with one or more receive chains in the access point, radio frequency signals associated with a wireless network transmitted from a plurality of user equipment; means for determining a positioning opportunity; means for receiving, with at least one of the one or more receive chains, radio frequency signals transmitted from a satellite vehicle based at least in part on determining the positioning opportunity; and means for estimating a position of the access point based at least in part on the radio frequency signals transmitted from the satellite vehicle.

Clause 74. A non-transitory processor-readable storage medium comprising processor-readable instructions configured to cause one or more processors to obtain a position estimate with an access point, comprising code for: receiving, with one or more receive chains in the access point, radio frequency signals associated with a wireless network transmitted from a plurality of user equipment; determining a positioning opportunity; receiving, with at least one of the one or more receive chains, radio frequency signals transmitted from a satellite vehicle based at least in part on determining the positioning opportunity; and estimating a position of the access point based at least in part on the radio frequency signals transmitted from the satellite vehicle.

1. A method for obtaining a position estimate with an access point, comprising:
receiving, with one or more receive chains in the access point, radio frequency signals associated with a wireless network transmitted from a plurality of user equipment;
determining a positioning opportunity;
receiving, with at least one of the one or more receive chains, radio frequency signals transmitted from a satellite vehicle based at least in part on determining the positioning opportunity; and
estimating a position of the access point based at least in part on the radio frequency signals transmitted from the satellite vehicle.

2. The method of claim 1, wherein determining the positioning opportunity includes receiving an indication from a network resource to perform navigation operations, wherein receiving radio frequency signals transmitted from the satellite vehicle with at least one of the one or more receive chains is based at least in part on the indication.

3. The method of claim 2, wherein the indication includes one or more time periods.

4. The method of claim 2, wherein the indication is included in one or more overlapping master neighbor (OMN) messages.

5. The method of claim 1, wherein determining the positioning opportunity is based at least in part on one or more of a time of day, network traffic information, historical information, network configuration information, and combinations thereof.

6. The method of claim 1, wherein determining the positioning opportunity is based at least in part on an available processing capability of the access point.

7. The method of claim 6, wherein the determining the available processing capability of the access point is based on a processing unit utilization level being below a threshold value.

8. The method of claim 6, wherein the determining the available processing capability of the access point is based on a number of user equipment in the plurality of user equipment being below a threshold.

9. The method of claim 1, further comprising transmitting schedule information to the plurality of user equipment, wherein the schedule information corresponds to a time period when the access point is configured to receive radio frequency signals transmitted from the satellite vehicle.

10. The method of claim 1, wherein receiving radio frequency signals transmitted from the satellite vehicle with at least one of the one or more receive chains includes coupling an antenna patch to the least one of the one or more receive chains.

11. An apparatus, comprising:
at least one memory;
a plurality of receive chains communicatively coupled to at least one transceiver;
at least one processor communicatively coupled to the at least one memory and the at least one transceiver, and configured to:
receive, with the plurality of receive chains, radio frequency signals associated with a wireless network transmitted from a plurality of user equipment;
determine a positioning opportunity;
receive, with at least one of the plurality of receive chains, radio frequency signals transmitted from a satellite vehicle based at least in part on determining the positioning opportunity; and
estimate a position based at least in part on the radio frequency signals transmitted from the satellite vehicle.

12. The apparatus of claim 11, wherein the at least one processor is further configured to receive an indication from a network resource to perform navigation operations to determine the positioning opportunity, and to receive radio frequency signals transmitted from the satellite vehicle with at least one of the plurality of receive chains based at least in part on the indication.

13. The apparatus of claim 12, wherein the indication includes one or more time periods.

14. The apparatus of claim 12, wherein the indication is included in one or more overlapping master neighbor (OMN) messages.

15. The apparatus of claim 11, wherein the at least one processor is further configured to determine the positioning opportunity based at least in part on one or more of a time of day, network traffic information, historical information, network configuration information, and combinations thereof.

16. The apparatus of claim 11, wherein the at least one processor is further configured to determine the positioning opportunity based at least in part on an available processing capability.

17. The apparatus of claim 16, wherein the at least one processor is further configured to determine the available processing capability based on a processing unit utilization level being below a threshold value.

18. The apparatus of claim 16, wherein the at least one processor is further configured to determine the available processing capability based on a number of user equipment in the plurality of user equipment being below a threshold.

19. The apparatus of claim 11, wherein the at least one processor is further configured to couple an antenna patch to the least one of the plurality of receive chains.

20. An apparatus for obtaining a position estimate with an access point, comprising:
means for receiving, with one or more receive chains in the access point, radio frequency signals associated with a wireless network transmitted from a plurality of user equipment;
means for determining a positioning opportunity;
means for receiving, with at least one of the one or more receive chains, radio frequency signals transmitted from a satellite vehicle based at least in part on determining the positioning opportunity; and
means for estimating a position of the access point based at least in part on the radio frequency signals transmitted from the satellite vehicle.
